(19) United States
(12) Patent Application Publication
(10) Pub. No.: US 2022/0179239 A1
(43) Pub. Date: Jun. 9, 2022

(54) LENS FOR SLOWING OR PREVENTING THE DEVELOPMENT OF MYOPIA

(71) Applicant: HOPE VISION CO., LTD., MIAOLI COUNTY (TW)

(72) Inventors: SHIH HONG CHU, TAICHUNG CITY (TW); CHAO CHENG CHEN, TOUFEN CITY (TW); YA RU BAI, TAINAN CITY (TW); HUAN CHIU TSEN, HSINCHU CITY (TW)

(21) Appl. No.: 17/202,875

(22) Filed: Mar. 16, 2021

(30) Foreign Application Priority Data
Dec. 7, 2020 (TW) 109142998

(51) Int. Cl. G02C 7/04; G02C 7/02

(52) U.S. Cl. CPC G02C 7/04; G02C 2202/24; G02C 7/022

(57) ABSTRACT

A lens for slowing or preventing the development of myopia includes an optical portion and a peripheral portion surrounding the optical portion. The distribution of the refractive power of the optical portion is expressed by an exponential growth function. Assume that a specific condition is satisfied. The farther away from the center of the lens, the greater the change in the refractive power. Thus, a defocus area is formed to control and prevent eye myopia. Besides, the distribution of refractive power can provide a larger visible area in order to effectively avoid visual instability caused by lens sliding.

This application claims priority of Application No. 109142998 filed in Taiwan on 7 Dec. 2020 under 35 U.S.C. § 119; the entire contents of all of which are hereby incorporated by reference.

### BACKGROUND OF THE INVENTION

### Field of the Invention

The present invention relates to an ophthalmic lens, particularly to a lens for slowing or preventing the development of myopia.

### Description of the Related Art

With the prevalence of 3C products, the age of myopia of school children has decreased year by year. The earlier myopia occurs, the more likely it is to evolve into high myopia. High myopia is prone to cause retinal detachment, macular degeneration, cataract and glaucoma, and even blindness. In addition to changing lifestyles, the current methods that can effectively control and prevent myopia from worsening year by year can also use ciliary muscle relaxants (mydriatics) or/and wear glasses to correct vision.

Contact lenses for myopia prevention and control are one of the focuses of research in recent years. Nowadays, the optical design of a contact lens for myopia prevention and control mainly provides a clear display picture corresponding to a visible area at the center of the lens and provides a blurred display picture corresponding to a peripheral area around the visible area, thereby slowing the development of eye myopia. Furthermore, light near the axis enters the eye and focuses on the eyeball while light away from the axis enters the eye and focuses on the front of the retina to cause a defocus phenomenon. Generally, the visible area of a contact lens extends from the center of the lens to outside and has a radial distance of 1.2 mm. The pupil size is generally lower than 1.2 mm. However, contact lenses are prone to shift during the wearing process, such as when the wearer blinks. In addition, the contact lens for myopia prevention and control is designed to have a defocus area outside the visible area. As a result, the lens will produce a great visual difference such that the wearer easily feels uncomfortable when the lens moves. Accordingly, the wearer does not wear the lens for a long time to reduce the effect of vision control.

### SUMMARY OF THE INVENTION

The primary objective of the present invention is to provide a lens for slowing or preventing the development of myopia, which includes an optical portion. The distribution of the refractive power of the optical portion is expressed by an exponential growth function. The optical portion provides a larger range of a visible area to avoid visual instability caused by lens sliding, thereby improving wearing comfort. Thus, the lens can effectively prevent myopia and control the development of myopia.

To achieve the abovementioned objectives, the present invention provides a lens for slowing or preventing the development of myopia, which includes an optical portion and a peripheral portion. The optical portion extends from a center of the lens to outside. The peripheral portion surrounds the optical portion. The distribution of a refractive power of the optical portion is expressed by a following exponential growth function:

y=BasePwr+Ae^{ix};
wherein 0<A<0.20, i=1˜6;
wherein y represents the refractive power of a position x, BasePwr represents a basic refractive power, A and i are parameters of the function, and x represents a radial distance from the center of the lens.

According to an embodiment of the present invention, the function further meets 0<x<3.5˜4.0 mm.

According to an embodiment of the present invention, the optical portion has a visible area, and the visible area has a radial distance of at least 1.2 mm extending from the center of the lens to outside.

According to an embodiment of the present invention, the visible area has a radial distance of at least 1.6 mm extending from the center of the lens to outside.

According to an embodiment of the present invention, the difference of the refractive power of the optical portion within the visible area is less than 0.25 diopters.

According to an embodiment of the present invention, the refractive power of the peripheral portion is different from that of the optical portion.

According to an embodiment of the present invention, the lens is a contact lens.

Below, the embodiments are described in detail in cooperation with the drawings to make easily understood the technical contents, characteristics and accomplishments of the present invention.

### BRIEF DESCRIPTION OF THE DRAWINGS

FIG. 1 is a top view of a lens for slowing or preventing the development of myopia according an embodiment of the present invention;

FIG. 2 is a diagram illustrating the refractive power-distributed curve of the optical portion of a lens for slowing or preventing the development of myopia according to a first embodiment of the present invention;

FIG. 3 is a diagram illustrating the refractive power-distributed curve of the optical portion of a lens for slowing or preventing the development of myopia according to a second embodiment of the present invention; and

FIG. 4 is a diagram illustrating the refractive power-distributed curve of the optical portion of a lens for slowing or preventing the development of myopia according to a third embodiment of the present invention.

### DETAILED DESCRIPTION OF THE INVENTION

The present invention provides a lens for slowing or preventing the development of myopia, which mainly increases a range of the visible area of an optical portion by adjusting the distribution of the refractive power of the optical portion. The present invention does not limit the distribution of the refractive power of a peripheral portion. Thus, in practice, the peripheral portion may be implemented with different optical designs according to requirement of products.

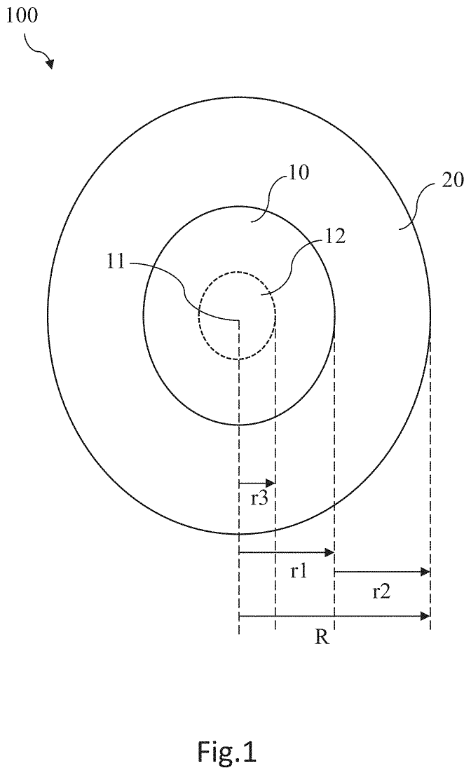

FIG. 1 is a top view of a lens 100 for slowing or preventing the development of myopia according an embodiment of the present invention. Referring to FIG. 1, the lens 100 includes an optical portion 10 and a peripheral portion 20. The optical portion 10 extends from the center 11 of the lens 100 to outside. The peripheral portion 20, surrounding the optical portion 10, is connected with the outer edge of the optical portion 10. The refractive power of the peripheral portion 20 is different from that of the optical portion 10. The distribution of the refractive power of the optical portion 10 is expressed by the following exponential growth function:

y=BasePwr+Ae^{ix};
wherein 0<A<0.20, i=1˜6;
wherein y represents the refractive power of a position x, BasePwr represents a basic refractive power, A and i are parameters of the function, and x represents a radial distance from the center 11 of the lens 100 and has a unit of millimeter (mm).

According to the abovementioned function, the center 11 of the lens 100 is used as a starting point (x=0). The position, which is a radial distance of x mm from the center 11 of the lens 100, has the value (diopter, D) of the refractive power y. In the abovementioned function, BasePwr needs to be adjusted according to each person's basic refractive power. A and i respectively affect the refractive power and the curve of the exponential growth function. A and i are adjusted according to requirement of products. Assume that the abovementioned condition is satisfied in the refractive power-distributed function. The farther away from the center of the lens, the greater the change in the refractive power. Thus, a defocus area is formed to suppress the eye axis length, thereby controlling and preventing eye myopia.

The lens 100 of the present invention may be a contact lens, such as a soft contact lens. The material of the contact lens includes, but not limited to, a water glue or a silicone water glue. In general, the contact lens has a radius of about 6.5˜7.5 mm. In the present invention, the optical portion 10 of the lens 100 has a radial distance r1 of 3.5˜4.0 mm extending from the center 11 of the lens 100 to outside. That is to say, the function preferably satisfies a condition of 0<x<3.5˜4.0 mm. The peripheral portion 20 of the lens 100 has a radial distance r2 of 3.0˜4.0 mm extending from the boundary of the optical portion 10 to outside.

In the present invention, the optical portion 10 of the lens 100 has a visible area 12. The difference of the refractive power of the optical portion 10 within the visible area 12 is less than 0.25 diopters. Because the eyes are adaptable, clear visual performance can still be obtained when the difference of the refractive power is less than 0.25 diopters. As a result, the visible area has the difference of the refractive power less than 0.25 diopters. The visible area 12 of the present invention has a radial distance r3 of at least 1.2 mm extending from the center 11 of the lens 100 to outside. In practical applications, the present invention can provide a larger range of the visible area 12. In a preferred embodiment, the visible area 12 may have a radial distance r3 of at least 1.6 mm extending from the center 11 of the lens 100 to outside. Thus, the visible area 12 can reduce visual difference and discomfort caused by shifting the lens 100.

The following embodiments are provided to explain the distribution of the refractive power in detail. It is easy to understand how the present invention is applied to actual product development. The present invention can indeed increase the range of the visible area, provide stable vision in the macular region of the retina, and avoid the intervention of adjustment caused by instability of vision to increase the strength of the lens 100. The peripheral portion can form a defocus imaging area to suppress the eye axis length, in order to effectively improve the effect of myopia prevention and control.

### First Embodiment

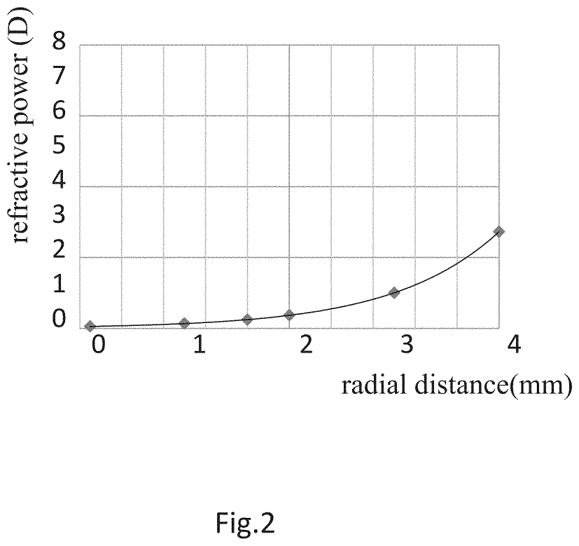

Referring to FIG. 2 and Table 1, FIG. 2 is a diagram illustrating the refractive power-distributed curve of the optical portion of a lens for slowing or preventing the development of myopia according to a first embodiment of the present invention. Table 1 shows a radial distance (x) from the center of the lens and the corresponding refractive power (y) in the first embodiment. In the first embodiment, the distribution of the refractive power of the optical portion is expressed by the following exponential growth function:

y=0.05e^{x};

wherein BasePwr=0, A is 0.05, and i is 1.

TABLE 1

| Radial distance (mm) | Refractive power (diopter, D) |
|---|---|
| 0.1 | 0.05 |
| 1 | 0.16 |
| 1.6 | 0.24 |
| 2 | 0.36 |
| 3 | 1.00 |
| 4 | 2.72 |

According to the distribution of the refractive power of the embodiment, the basic refractive power BasePwr of a user is 0 and the variable parameter A is set to be equal to or less than 0.05 (0<A≤0.05). Thus, a position, which is a radial distance x of 1.6 mm from the center of the lens, has the refractive power y of less than 0.25 diopters. As a result, the refractive power-distributed curve of the lens of the embodiment may be used to enlarge the range of the visible area.

### Second Embodiment

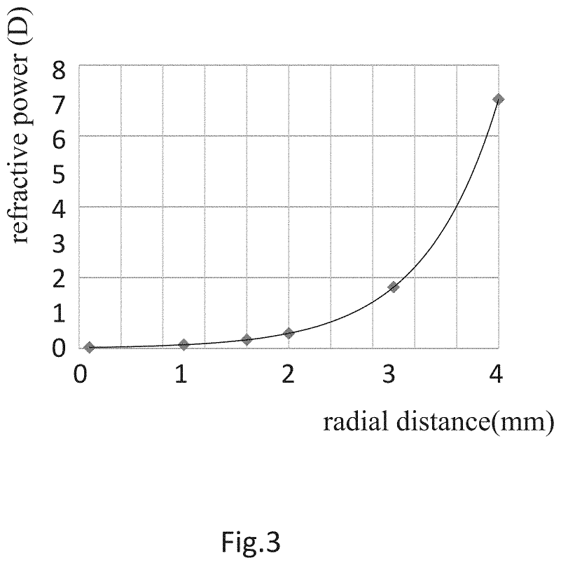

Referring to FIG. 3 and Table 2, FIG. 3 is a diagram illustrating the refractive power-distributed curve of the optical portion of a lens for slowing or preventing the development of myopia according to a second embodiment of the present invention. Table 2 shows a radial distance (x) from the center of the lens and the corresponding refractive power (y) in the second embodiment. In the second embodiment, the distribution of the refractive power of the optical portion is expressed by the following exponential growth function:

y=0.026e^{1.4x};

wherein BasePwr=0, A is 0.026, and i is 1.4.

TABLE 2

| Radial distance (mm) | Refractive power (diopter, D) |
|---|---|
| 0.1 | 0.02 |
| 1 | 0.10 |
| 1.6 | 0.24 |
| 2 | 0.42 |
| 3 | 1.73 |
| 4 | 7.03 |

According to the distribution of the refractive power of the embodiment, the basic refractive power BasePwr of a user is 0 and the variable parameter A is set to be equal to or less than 0.026 (0<A≤0.026). Thus, a position, which is a radial distance x of 1.6 mm from the center of the lens, has the refractive power y of less than 0.25 diopters. As a result, the refractive power-distributed curve of the lens of the embodiment may be used to enlarge the range of the visible area. In addition, a position, which is a radial distance x of 4 mm from the center of the lens, has the refractive power y of less than the maximum refractive power of 8 diopters, thereby improving the effect of myopia prevention and control.

### Third Embodiment

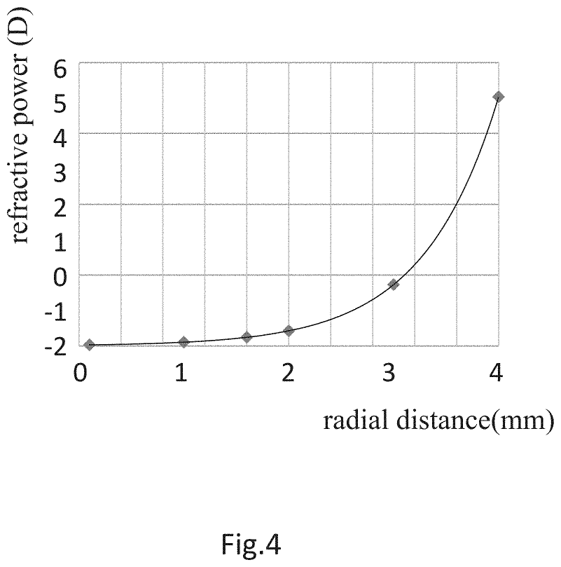

Referring to FIG. 4 and Table 3, FIG. 4 is a diagram illustrating the refractive power-distributed curve of the optical portion of a lens for slowing or preventing the development of myopia according to a third embodiment of the present invention. Table 3 shows a radial distance (x) from the center of the lens and the corresponding refractive power (y) in the second embodiment. In the second embodiment, the distribution of the refractive power of the optical portion is expressed by the following exponential growth function:

y=−2+0.026e^{1.4x};

wherein BasePwr=−2, A is 0.026, and i is 1.4.

TABLE 3

| Radial distance (mm) | Refractive power (diopter, D) |
|---|---|
| 0.1 | −1.98 |
| 1 | −1.9 |
| 1.6 | −1.76 |
| 2 | −1.58 |
| 3 | −0.27 |
| 4 | 5.03 |

According to the distribution of refractive power of the embodiment, the basic refractive power BasePwr of a user is −2 and the other parameter of the third embodiment is the same to that of the second embodiment when the vision of the user is poor. That is to say, when the parameter A in the function is set to be equal to or less than 0.026 (0<A≤0.026), the refractive power-distributed curve of the lens of the embodiment may be used to enlarge the range of the visible area. In addition, a position, which is a radial distance x of 4 mm from the center of the lens, has the refractive power y of less than the maximum refractive power of 8 diopters, thereby improving the effect of myopia prevention and control.

In conclusion, the present invention provides the lens for slowing or preventing the development of myopia, wherein the distribution of the refractive power of the optical portion is expressed by an exponential growth function. When the function satisfies a specific condition, a larger range of the visible area can be provided to avoid a great visual difference and discomfort in shifting and wearing the lens. Accordingly, the lens is suitable for wearers to wear for a long time and helpful in achieving good vision control.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A lens for slowing or preventing the development of myopia, comprising:
an optical portion extending from a center of the lens to outside; and
a peripheral portion surrounding the optical portion;
wherein a distribution of a refractive power of the optical portion is expressed by a following exponential growth function:
y=BasePwr+Ae^{ix};
wherein 0<A<0.20, i=1˜6;
wherein y represents the refractive power of a position x;
BasePwr represents a basic refractive power;
A and i are parameters of the function; and
x represents a radial distance from the center of the lens.

2. The lens for slowing or preventing the development of myopia according to claim 1, wherein the function further meets 0<x<3.5˜4.0 mm.

3. The lens for slowing or preventing the development of myopia according to claim 1, wherein the optical portion has a visible area, and the visible area has a radial distance of at least 1.2 mm extending from the center of the lens to outside.

4. The lens for slowing or preventing the development of myopia according to claim 3, wherein the visible area has a radial distance of at least 1.6 mm extending from the center of the lens to outside.

5. The lens for slowing or preventing the development of myopia according to claim 3, wherein a difference of the refractive power of the optical portion within the visible area is less than 0.25 diopters.

6. The lens for slowing or preventing the development of myopia according to claim 1, wherein the refractive power of the peripheral portion is different from that of the optical portion.

7. The lens for slowing or preventing the development of myopia according to claim 1, wherein the lens is a contact lens.
